(19) United States
(12) Patent Application Publication
(10) Pub. No.: US 2018/0229654 A1
(43) Pub. Date: Aug. 16, 2018

(54) SENSING APPLICATION USE WHILE DRIVING

(71) Applicant: Regents of the University of Minnesota, Minneapolis, MN (US)

(72) Inventors: Baris Unver, Minneapolis, MN (US); Colleen Smith, Minneapolis, MN (US)

(21) Appl. No.: 15/897,849

(22) Filed: Feb. 15, 2018

Related U.S. Application Data
(60) Provisional application No. 62/459,840, filed on Feb. 16, 2017.

(51) Int. Cl. B60Q 9/00; H04M 1/725; H04W 4/40; G06K 9/00

(52) U.S. Cl. CPC B60Q 9/00; G06K 9/00845; H04W 4/40; H04M 1/72569

(57) ABSTRACT

A method includes determining a gaze parameter for how a user gazes relative to a mobile device and based on the gaze parameter, determining whether the user is a driver of a vehicle or a passenger of the vehicle. When the user is determined to be the driver, an alert is sent.

### CROSS-REFERENCE TO RELATED APPLICATION

The present application is based on and claims the benefit of U.S. provisional patent application Ser. No. 62/459,840, filed Feb. 16, 2017, the content of which is hereby incorporated by reference in its entirety.

### BACKGROUND

Using a mobile device, such as a Smartphone, or a built-in video display while driving has been shown to be extremely dangerous since the Smartphone/display distracts the driver's attention away from the roadway. Nonetheless, Smartphones and vehicle displays can be useful in a vehicle especially to passengers, whose use of the Smartphone/vehicle display poses no threat to highway safety.

The discussion above is merely provided for general background information and is not intended to be used as an aid in determining the scope of the claimed subject matter. The claimed subject matter is not limited to implementations that solve any or all disadvantages noted in the background.

### SUMMARY

A method includes determining a gaze parameter for how a user gazes relative to a mobile device and based on the gaze parameter, determining whether the user is a driver of a vehicle or a passenger of the vehicle. When the user is determined to be the driver, an alert is sent.

In accordance with a further embodiment, a method includes using images from multiple cameras to determine gaze locations of an occupant of a vehicle and using the gaze locations to determine gaze parameters for the occupant. From the gaze parameters, a determination is made as to whether the occupant is a driver who is paying too much visual attention to an application.

In a still further embodiment, a mobile device includes a display and a processor. The processor executes instructions to identifying which application is currently being shown on the display, retrieving a gaze parameter associated with the identified application and using the gaze parameter to determine if a user of the mobile device is driving a vehicle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side view showing a driver holding a mobile device while concentrating on the roadway.

FIG. 2 shows the same driver of FIG. 1 viewing the mobile device instead of the roadway.

FIG. 3 shows an embodiment wherein the mobile device is mounted to the vehicles dashboard instead of being held in the user's hand.

FIG. 4 provides an example of an image captured by the mobile device in FIG. 1.

FIG. 5 provides an example of an image captured by the mobile device in FIG. 2.

FIG. 6 provides a flow diagram of a method in accordance with one embodiment.

FIG. 7 provides a block diagram of elements of mobile device 102 and vehicle 101 in an exemplary system.

FIG. 8 provides an alternative embodiment of the flow diagram of FIG. 6.

FIG. 9 is a flow diagram of a method of determining if a driver is paying too much visual attention to an application in accordance with a further embodiment.

### DETAILED DESCRIPTION

Although mobile devices have been able to estimate whether they are moving in a vehicle, it has been difficult to identify whether a driver or a passenger is using the mobile device. Because of this, it has been difficult to set limits on what applications can be used in a mobile device when it is moving in a vehicle. If users are prevented from using any application on the mobile device while the mobile device is in a vehicle, then passengers are unnecessarily deprived of their mobile device. Alternatively, if the driver is allowed to use all applications on their mobile device while driving, there is a substantial likelihood that the driver will be distracted from driving.

In the embodiments described below, a method is provided for identifying when the mobile device or other electronic display in a vehicle is being used by a driver instead of a passenger. This method improves highway safety while making the mobile device/display available at all times for passengers. The method also improves battery life of the mobile device by only executing the driver determination software when the current application is one of a group of applications that have been identified as being dangerous to use while driving. Some applications, such as navigation applications, can be beneficial to driving and thus should not be barred by the system. When such beneficial applications are being executed by the mobile device, the present invention saves the battery life by not performing the driver identification tasks.

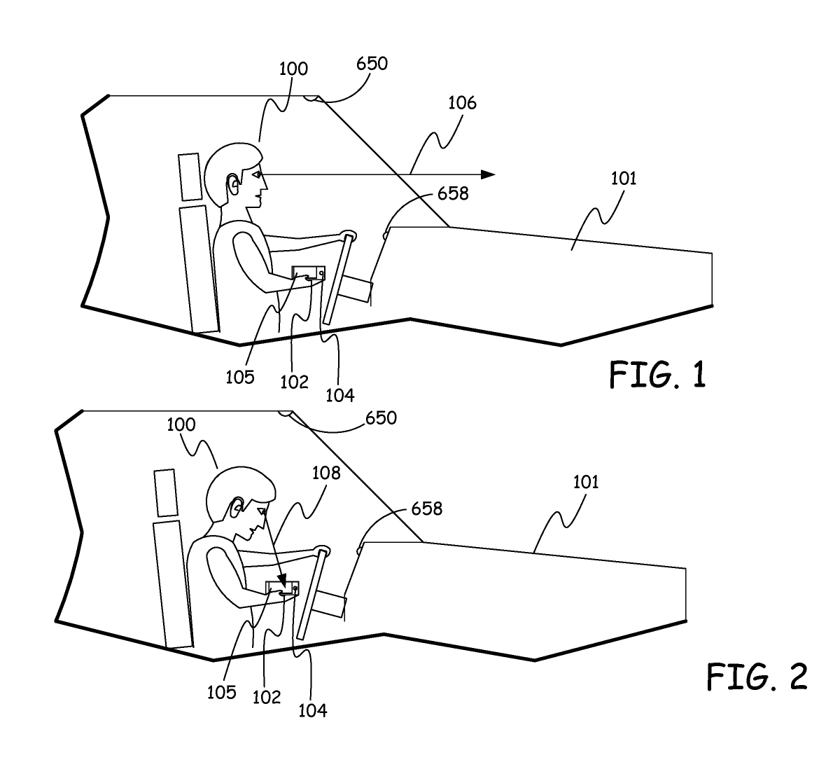

FIG. 1 provides a side view of an occupant 100 of a vehicle 101 who is holding a mobile device 102. Mobile device 102 includes a camera 104 and a display 105. In FIG. 1, occupant 100 is viewing the road along a direction 106. FIG. 2 shows the same occupant 100 viewing mobile device 102 along a direction 108. Although occupant 100 is shown as the driver of vehicle 101 in FIGS. 1 and 2, in other instances, occupant 100 is a passenger in vehicle 101.

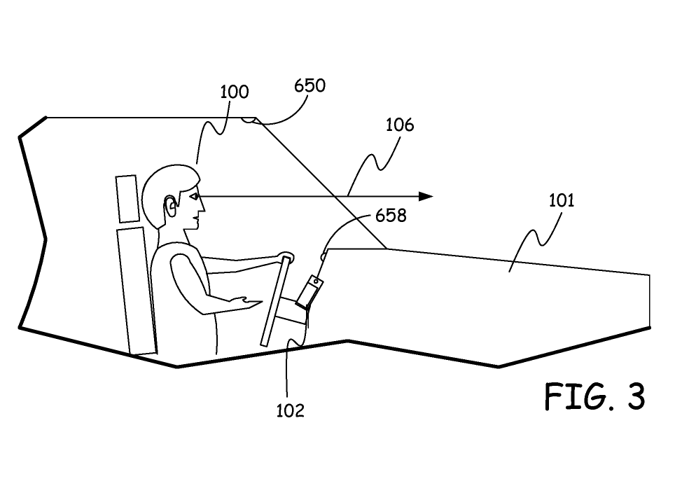

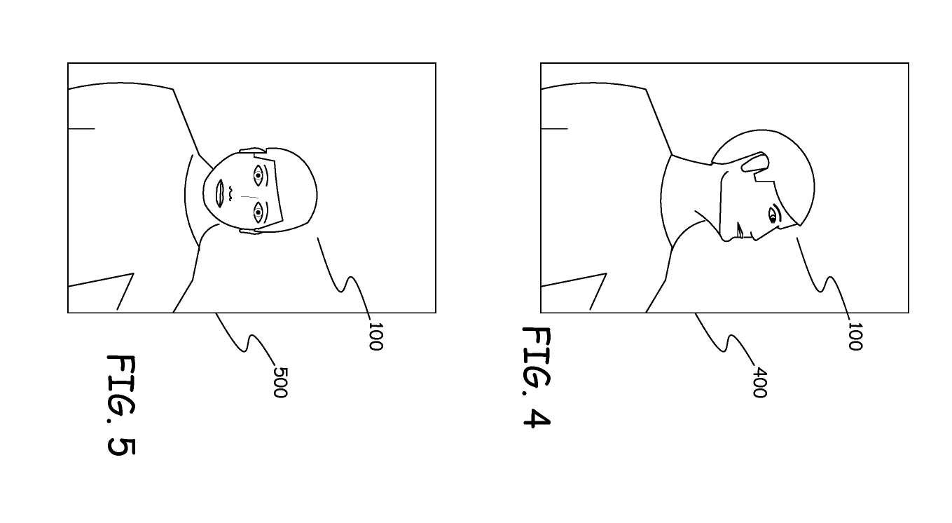

Cameras mounted to vehicle 101 and/or on mobile device 102 are able to capture images of occupant 100 and other occupants of vehicle 101. For example, cameras 650 and 658 in vehicle 101 and camera 104 of mobile device 102 are able to capture images of occupant 100 and other occupants of vehicle 101. Although two cameras are shown mounted to the dashboard and the ceiling of vehicle 101, in other embodiments, other numbers of cameras are mounted to vehicle 101 and/or cameras are mounted in different locations in vehicle 101. Further, instead of mobile device 102 being held by occupant 100, in other embodiments, mobile device 102 is mounted to the vehicle by a holder as shown in FIG. 3. In still further embodiments, a fixed electronic display is incorporated in the dashboard or some other part of the vehicle.

FIG. 4 shows an example of an image 400 of occupant/user 100 captured by camera 104 while occupant 100 is glancing along direction 106 as shown in FIG. 1. FIG. 5 shows an example of an image 500 captured by camera 104 when occupant 100 is glancing at the phone along direction 108 as shown in FIG. 2.

In accordance with one embodiment, gaze tracking software is used to track the gaze of one or more occupants of vehicle 101 to determine whether a driver or a passenger is using particular mobile devices or vehicle displays and for the driver of vehicle 101, to determine the level of attention that the driver is paying to mobile device 102 or a vehicle display.

Gaze tracking involves identifying a series of gaze points, which are locations where the user is focusing their eyes. A consecutive sequence of gaze points that are in close spatial proximity to each other form a glaze cluster referred to as a fixation. Eye movement between fixations is referred to as a saccade and involves a fast movement of the eyes across a significant distance from one fixation to another.

The present inventors have discovered that the locations of fixations, the length of time of each fixation, the length of time of each saccade and the frequency with which an occupant looks away and back to the mobile device (glancing frequency) are different for a drive of a vehicle than for a passenger. Specifically, drivers tend to have more fixation locations, shorter fixation times, shorter saccade times, and higher glancing frequencies than passengers. In addition, the present inventors have discovered that these gaze parameters change based on the level of attention that a driver is paying to the mobile device or vehicle display allowing for a distinction between active use of the mobile device/vehicle display and passive use of the mobile device/vehicle display. For example, these features of the user's gaze are different when the user is reading text on the mobile device (active use) than when the user is listening to audio from the mobile device (passive use).

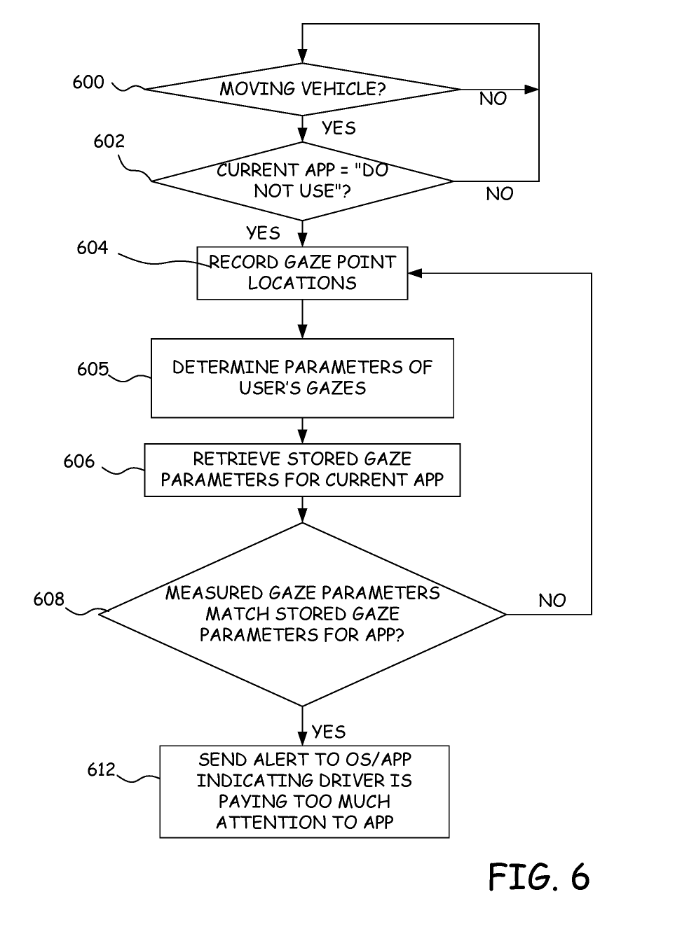

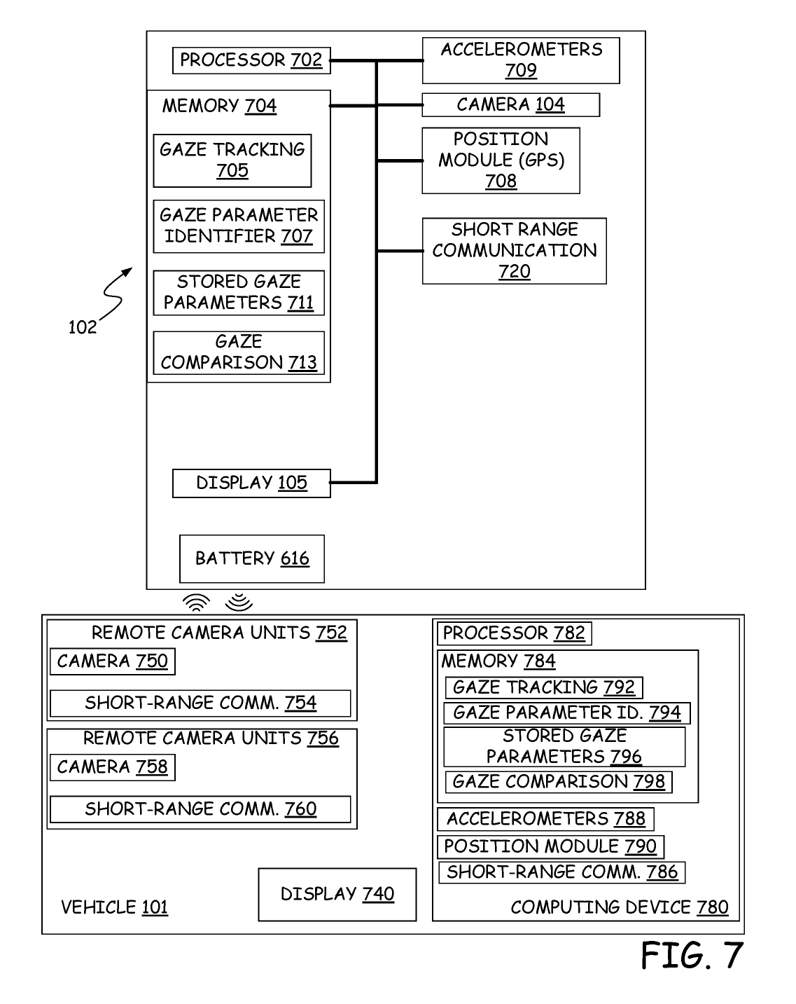

FIG. 6 provides a flow diagram of a method of identifying who is using a mobile device/vehicle display and the level of visual attention they are paying to the mobile device/vehicle display in accordance with one embodiment. FIG. 7 provides a block diagram of mobile device 102 and vehicle 101 that cooperate to form a system used the method of FIG. 6.

In FIG. 7, mobile device 102 is shown to include a processor 702 that executes software modules 705, 707, and 713 stored in a memory 704 and that is connected by one or more buses, interfaces and drivers to various sensors and communication systems including accelerometers 709, camera 104, a position module 708, a wireless short-range communication unit 720, and a display 710. Similarly, a computing device 780 is shown to be mounted within vehicle 101 and includes a processor 782 that executes software modules 792, 794, and 798 stored in a memory 784 and that is connected by one or more buses, interfaces and drivers to various sensors and communication systems including accelerometers 788, position module 790 and a wireless short-range communication unit 786. In accordance with some embodiments, computing device 780 is a dedicated controller. Mobile device 102 also includes a battery 616 for powering all of the other elements within mobile device 102 while computing device 780 receives power from an electrical source in vehicle 101. Vehicle 101 also includes one or more vehicle displays 740.

At step 600, processor 702 in mobile device 102 or processor 782 in computing device 780, determines if vehicle 101 is moving. In accordance with one embodiment, processor 702 makes this determination based on values received from a position module 708, such as a global positioning system and/or signals from accelerometers 709 located within mobile device 102. Alternatively, processor 782 makes this determination based on values received from a position module 790, such as a global positioning system and/or signals from accelerometers 788 in or connected to computing device 780. Position modules 708/790 provide a stream of position values and velocity values for mobile device 102/vehicle 101 based on satellite signals or other communication signals exterior to mobile device 102/vehicle 101. Accelerometers 709/788 provide acceleration values along different axes indicating how mobile device 102/vehicle 101 is being accelerated. Processors 702/782 compare the velocity determined from accelerometers 709/788 and/or position module 708/790 to stored velocity values associated with movement of a vehicle. In particular, when the velocity of mobile device 102/vehicle 101 exceeds a threshold, processors 702/782 determine that vehicle 101 is moving and the process of FIG. 6 continues at step 602. When the detected motion does not indicate that vehicle 101 is moving, the process returns to step 600 to wait for the motion to indicate that vehicle 101 is moving.

In other embodiments, processor 782 determines that vehicle 101 is moving based on other data collected by vehicle 101 including whether vehicle 101 is in drive or reverse as determined by a gear detection sensor/system (not shown), and the current speed of vehicle 101 as measured by a speedometer (not shown) in vehicle 101.

In embodiments where processor 782 determines that vehicle 101 is moving, processor 782 conveys this information to each mobile device in vehicle 101 using a wireless short-range communication module 786, which communicates with a corresponding wireless short-range communication module in the mobile device such as wireless short-range communication module 720 in mobile device 102. Examples of wireless short-range communication modules include communication modules that use a Near-field communication standard or communication modules that use a Bluetooth communication standard, for example.

When the detected motion indicates vehicle 101 is moving, processor 702/782 performs step 602 to determine if the current application being shown on mobile device 102/vehicle display 740 has been designated as a “Do Not Use” while driving application. Such a designation can be set as a parameter in the settings of the application or can be found in a list of “Do Not Use” applications maintained by mobile device 102/computing device 780. In accordance with some embodiments, only certain applications require the determination of whether a driver or a passenger is using the application and/or the level of attention a driver is paying to mobile device 102/vehicle display 740. If the current application has not been designated as a “Do Not Use” while driving application, there is no need to determine whether the driver is using the device or the driver's level of visual attention and the process returns to step 600. By not making the determination of whether it is the driver or a passenger using mobile device 102/vehicle display 740 for some applications, the various embodiments reduce battery usage on mobile device 102 and processor usage in mobile device 102 and computing device 780.

When the current application is designated as a “Do Not Use” while driving application, the process of FIG. 6 continues at step 604 where one of processors 702 and 782 records gaze point locations that describe when and where the user is looking during each of a series of time points.

To determine the gaze point locations, processor 702/782 executes gaze tracking modules 705/792 in memory 704/784. Gaze tracking modules 705/792 activate one or more cameras such as internal camera 104 in mobile device 102 and cameras 750 and 758 in remote camera units 752 and 756 positioned within vehicle 101. In accordance with one embodiment, processor 702 communicates with cameras 750 and 758 through wireless short-range communication unit 720 in mobile device 102 and corresponding wireless short-range communication units 754 and 758 in remote camera units 752 and 756. Similarly, processor 782 communicates with cameras 750 and 758 through wireless short-range communication unit 786 and wireless short-range communication units 754 and 758. In other embodiments, remote camera units 752 and 756 are wired directly to computing device 780 such that processor 782 communicates with cameras 750 and 758 over a wired connection. In still further embodiments, computing device 780 acts as a relay for communications between processor 702 on mobile device 102 and cameras 750 and 758. In particular, when remote camera units 752 and 756 are wired to computing device 780, remote camera units 752 and 756 send image data over the wired connections to computing device 780, which then relays the messages to mobile device 102 through wireless short-range communication units 786 and 720.

In some embodiments, one or more of internal camera 104 and remote cameras 750 and 758 has a fish-eye lens. In other embodiments, one or more of internal camera 104 and remote cameras 750 and 758 is an infrared camera that can overcome low light conditions, glare and sun glass use.

When using a single camera to identify a location of a gaze point, the camera provides a sequence of images to gaze tracking software 705/792. For each image from the camera, gaze tracking software 705/792 determines the orientation and location of the pupils and the head, which it then uses to identify the location of the user's gaze point.

In embodiments that utilize multiple cameras, each camera provides a sequence of images of the user. Each image in the sequence of images is provided to gaze tracking software 705/792 to determine a direction of the gaze of the user. By using images from different cameras for the same point in time, it is possible to construct a three-dimensional model of the user's head and eyes and use that model to estimate the location of each gaze point. In further embodiments, one or more of the remote cameras capture the mobile device in an image and gaze tracking software 705/792 is able to use the image(s) to determine the position and orientation of mobile device camera 104 relative to a point in the vehicle. Once the position and orientation of camera 104 is known, images captured by camera 104 can be used as part of determining the locations of the gaze points relative to the vehicle.

At step 605, the series of gaze point locations is used by a gaze parameter identification module 607/794 to identify clusters of gaze points as fixations and to identify eye movements between fixations as saccades. Gaze parameter identification module 607/794 records the time points for the beginning and end of each saccade. The time from the beginning of a saccade to an end of a saccade is saved as the time length of the saccade and the time from the end point of one saccade to the beginning of the next saccade is saved as the fixation time for a fixation. In addition, the centroid of the gaze points between saccades is stored as the location of the fixation. The average time it takes for the user to look away from the mobile device, look back at the mobile device and look away again is used to determine an average frequency with which the user is glancing away from the mobile device.

At step 606, processor 702/782 retrieves stored gaze parameters 611/796. Stored gaze parameters 611/796 describe ranges of values for frequencies of glancing away from the mobile device/vehicle display, the locations of fixations, the length of time of each fixation, and the length of time of saccades that are associated with a driver who is actively using an application, a driver who is passively using an application and/or a passenger using an application while in a moving vehicle. In accordance with some embodiments, the stored gaze parameters 611/796 are application specific such that different applications have different gaze parameters. For instance, a texting application may have a low frequency of glancing toward and away from the application whereas a video streaming application will have a high frequency of glancing to and away from the application. When the stored gaze parameters 796 are application specific and the application is being executed on mobile device 102, processor 702 conveys the identity of the current application on mobile device 102 to processor 782 so that processor 782 can use the identity of the current application to retrieve the correct stored gaze parameters. When the stored gaze parameters 711 are application specific and the application is being displayed on vehicle display 740, processor 782 conveys the identity of the current application on vehicle display 740 to processor 702 so that processor 702 can use the identity of the current application to retrieve the correct stored gaze parameters.

At step 608, a gaze comparison module 713/798 executed by processor 702/782 determines if the measured gaze parameters are within the ranges stored for a driver who is paying too much visual attention to the application. If the gaze parameters are within such ranges, processor 702/782 determines that a driver is using the mobile device and is paying too much visual attention to the application and sends an alert to an operating system on which the application is running or to the application itself at step 612. The operating system and/or the application may then take steps to stop the user from using the application including warning the user that continued use of the application is dangerous, and/or turning off the application to prevent the user from using the application.

When the measured gaze parameters are not within the ranges stored for drivers who are paying too much visual attention to the application at step 608, the process returns to step 604 to collect a new set of gaze point locations for the user. This is done because it is possible for a mobile device to be handed from a passenger to the driver or for the driver's level of visual attention to the application to change or for the current application to change. By returning to step 604 and repeating steps 605, 606 and 608, the present embodiments are able to detect such changes and to re-determine if a driver is currently paying too much visual attention to a displayed application.

In an alternative embodiment, a machine learning algorithm is used to train a convolution neural network that can be used to determine if a driver is paying too much visual attention to an application. In such embodiments, fixation locations, fixation time periods, saccade time periods and glancing frequencies are determined for a variety of different people under a variety of different conditions while using different applications. Attributes of the various people, such as age, driving experience, gender, and height, for example, can be recorded along with the attributes of the various testing conditions such as weather, time of day, traffic, road type, vehicle type, type of mobile device, location of mobile device, vehicle speed, number of occupants in the vehicle, whether the user was the driver or passenger, and the type of application on the mobile device, for example. A neural network is then trained that associates the attributes of the user and the attributes of the conditions with the fixation locations, fixation time periods, saccade time periods and glancing frequencies to provide an output determination of whether a passenger is using the application or a driver is using the application, and whether the driver is paying too much visual attention to the application. In embodiments that use a neural network, stored gaze parameters 611/786 include the neural network's definitions.

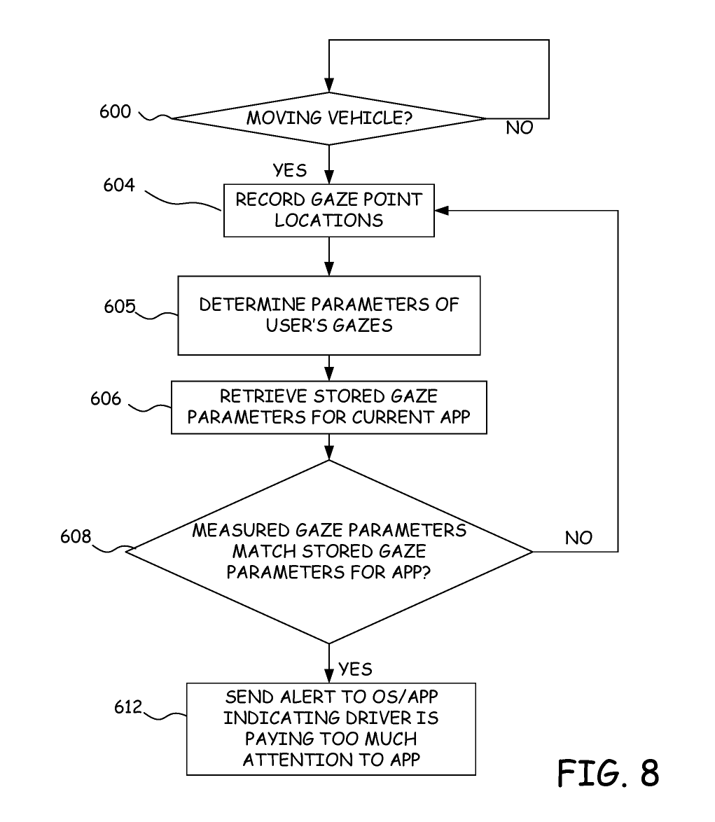

FIG. 8 provides an alternative embodiment to the method of FIG. 6 where step 602 is not performed.

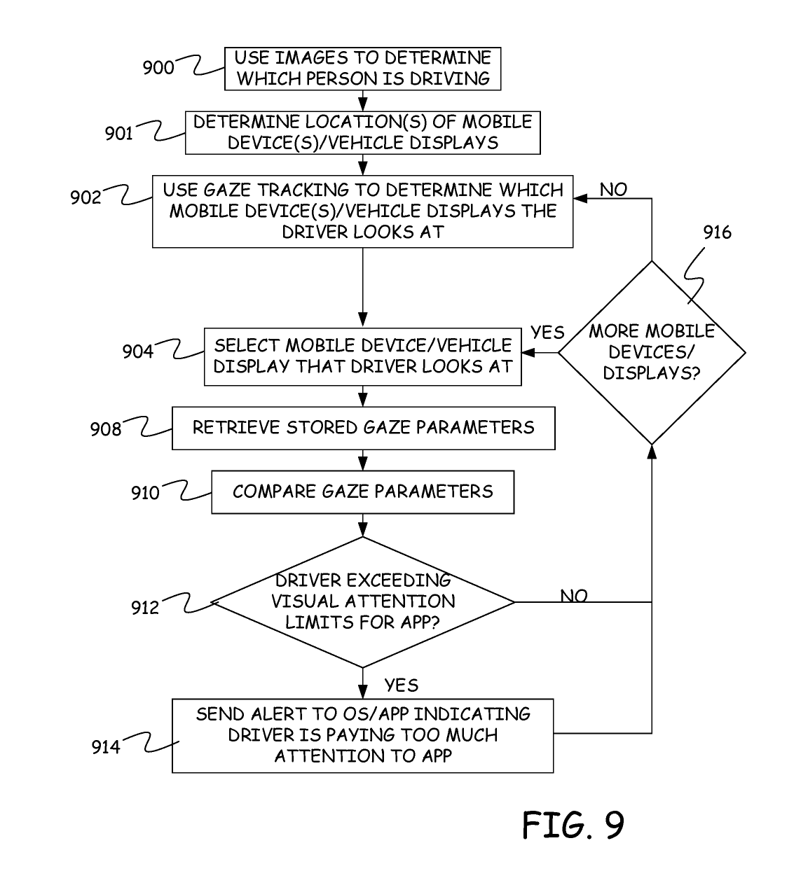

FIG. 9 provides an alternative method in accordance with one embodiment. In step 900, processor 702/782 uses an image or images from one or more of camera 104, camera 750 and/or camera 758 to identify the occupant who is driving the vehicle. In accordance with one embodiment, this is performed by locating the occupant in the driver's seat of the vehicle based on the locations of the occupants in the image. In other embodiments, step 900 is performed by identifying elements of the vehicle, such as the steering wheel, in the image and determining the position of the occupants relative to those elements.

At step 901, processor 702/782 determines the location of mobile devices and other electronic displays in vehicle 101. In accordance with one embodiment, the location of the electronic displays is recorded in memory 784 relative to a three-dimensional model of vehicle 101 maintained in memory 784. The location of mobile devices in vehicle 101 is determined from images captured by one or more of camera 104, camera 750 and/or camera 758 and can either be defined relative to a point in the vehicle or relative to the driver. For images captured by camera 104, the location of mobile device 102 is determined relative to a point in vehicle 101 by identifying landmarks in vehicle 101 found in the image and estimating the location and orientation of camera 104 based on the positions of the landmarks in the image. For images captured by the cameras 750 and 758, the location of a mobile device is determined relative to a point in vehicle 101 by identifying the mobile device and vehicle landmarks in an image and estimating the location and orientation of the mobile device from those identified features. In other embodiments, the location of mobile device 102 is determined relative to the driver from images captured by camera 104 by determining the location of the driver in the images captured by camera 104. The location of a mobile device relative to the driver can also be determined from images captured by cameras 750 and 758 that include at least a portion of the mobile device and at least a portion of the driver.

At step 902, gaze tracking module 707/792 and gaze parameter identification module 607/794 are used to determine which mobile device(s)/vehicle display(s) the driver is looking at. Specifically, gaze tracking module 707/792 determines a series of gaze location points for the driver and the series of gaze point locations is used by gaze parameter identification module 607/794 to identify clusters of gaze points as fixations. The location of each fixation is compared to the location of each mobile device and each vehicle display to determine which mobile devices and which vehicle displays the driver looks at.

In accordance with one embodiment, gaze parameter identification module 607/794 also records the time points for the beginning and end of each saccade. The time from the beginning of a saccade to an end of a saccade is saved as the time length of the saccade and the time from the end point of one saccade to the beginning of the next saccade is saved as the fixation time for a fixation. The average time it takes for the user to look away from a mobile device/vehicle display, look back at the mobile device/vehicle display and look away again is used to determine an average frequency with which the user is glancing away from the mobile device/vehicle display.

At step 904, one of the mobile device(s)/vehicle display(s) that the driver looked at is selected. At step 908, processor 702/782 retrieves stored gaze parameters 611/796 and at step 910, gaze comparison module 713/798 executed by processor 702/782 determines if the measured gaze parameters are within the ranges stored for a driver who is paying too much visual attention to the application. If the gaze parameters are within such ranges, processor 702/782 determines that the driver is paying too much visual attention to the application at step 912 and sends an alert to an operating system on which the application is running or to the application itself at step 914. The operating system and/or the application may then take steps to stop the user from using the application including warning the user that continued use of the application is dangerous, and/or turning off the application to prevent the user from using the application. If the driver is not paying too much visual attention to the application at step 912 or after an alert is sent to the operating system/application at step 914, the method continues at step 916, where it determines if there are more mobile devices/vehicle displays that the driver looked at. If there are more devices/displays, the process returns to step 904 to select a different mobile device/vehicle display that the driver looked at. If there are no more devices/displays that the driver looked at, the process returns to step 902 to record new gaze locations and gaze parameters before repeating steps 904-916.

Other embodiments are contemplated including detecting any or a combination of the following visual patterns:

glancing off-screen with a distinct and measurable frequency;

glancing in a particular direction with a distinct and measurable frequency;

glancing in a particular direction for a defined percentage of time; and

maintaining gaze at the screen only up to a certain maximal amount of time.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
determining a gaze parameter for how a user gazes relative to a mobile device;
based on the gaze parameter, determining whether the user is a driver of a vehicle or a passenger of the vehicle; and
when the user is determined to be the driver, sending an alert.

2. The method of claim 1 wherein the gaze parameter comprises a frequency at which a user looks away from the mobile device and wherein determining whether the user is a driver of a vehicle comprises comparing the frequency at which a user looks away from the mobile device to a range of frequencies associated with drivers.

3. The method of claim 2 wherein the range of frequencies associated with the driver is selected based on an application that is being executed by the mobile device.

4. The method of claim 1 wherein the gaze parameter comprises the direction where the user looks when they look away from the device and using the direction to determine whether the user is the driver of the vehicle.

5. The method of claim 1 wherein when the user is determined to not be the driver, repeating the step of determining the gaze parameter of the user to re-determine if the user is the driver.

6. The method of claim 1 further comprising before determining the gaze parameter, determining that the current application being executed by the mobile device is a do not use while driving application.

7. The method of claim 6 wherein the step of determining the gaze parameter is only performed if the current application is a do not use while driving application.

8. A method comprising:
using images from multiple cameras to determine gaze locations of an occupant of a vehicle;
using the gaze locations to determine gaze parameters for the occupant;
determining from the gaze parameters if the occupant is a driver who is paying too much visual attention to an application.

9. The method of claim 8 wherein determining if the occupant is a driver who is paying too much visual attention to an application comprises:
comparing the determined gaze parameters to at least one stored gaze parameter for drivers; and
when the determined gaze parameter matches the at least one stored gaze parameter for drivers, determining that the user is a driver who is paying too much visual attention to the application.

10. The method of claim 9 wherein the at least one stored gaze parameter for drivers is selected based on the application.

11. The method of claim 8 wherein determining gaze parameters for the occupant comprises:
determining fixation locations;
determining fixation time periods;
determining saccade time periods; and
determining a frequency with which the occupant looks away from the application.

12. The method of claim 11 wherein the multiple cameras comprise a camera on a mobile device and a camera attached to a vehicle.

13. The method of claim 8 wherein determining from the gaze parameters if the occupant is a driver who is paying too much visual attention to an application comprises applying the gaze parameters to a neural network.

14. The method of claim 13 wherein the neural network further takes as input at least one of weather conditions, traffic, and vehicle speed.

15. A mobile device comprising:
a display;
a processor executing instructions to perform steps of:
identifying which application is currently being shown on the display;
retrieving a gaze parameter associated with the identified application; and
using the gaze parameter to determine if a user of the mobile device is driving a vehicle.

16. The mobile device of claim 15 wherein the retrieved gaze parameter comprises at least one frequency with which drivers of a vehicle look away from the display when the application is shown on the display.

17. The mobile device of claim 16 wherein using the at least one frequency to determine if the user is driving a vehicle comprises determining a frequency with which the user looks away from the display and comparing the determined frequency to the retrieved at least one frequency.

18. The mobile device of claim 15 wherein the retrieved gaze parameter comprises at least one direction that drivers of vehicle look toward when they look away from the display when the application is shown on the display.

19. The mobile device of claim 18 wherein using the at least one direction to determine if the user is driving a vehicle comprises determining a direction where the user looks when the user looks away from the display and comparing the determined direction to the retrieved at least one direction.

20. The mobile device of claim 15 wherein before retrieving the gaze parameter, determining that the application currently shown on the display is designated as a do not use while driving application.
